(19) United States
(12) Patent Application Publication
(10) Pub. No.: US 2018/0281452 A1
(43) Pub. Date: Oct. 4, 2018

(54) THERMAL HEAD AND THERMAL PRINTER

(71) Applicant: KYOCERA Corporation, Kyoto-shi, Kyoto (JP)

(72) Inventors: Takahiro SHIMOZONO, Okaya-shi (JP); Kouji SHIMADA, Okaya-shi (JP); Arata OKAYAMA, Uji-shi (JP)

(73) Assignee: KYOCERA Corporation, Kyoto-shi, Kyoto (JP)

(21) Appl. No.: 15/763,367

(22) PCT Filed: Sep. 27, 2016
(86) PCT No.: PCT/JP2016/078460

§ 371 Date: Mar. 26, 2018

(30) Foreign Application Priority Data
Sep. 28, 2015 (JP) 2015-189895
Feb. 25, 2016 (JP) 2016-034515

(51) Int. Cl. B41J 2/335

(52) U.S. Cl. CPC B41J 2/3352

(57) ABSTRACT

A thermal head includes: a head base body including a substrate and a plurality of heat generating sections disposed on the substrate; connection portions which are electrically connected to the head base; a connection member which is electrically connected to the connection portions; and a first cover member which covers the connection portions, the first cover member including a plurality of protruding portions provided on an upper surface of the first cover member at predetermined intervals in a main scanning direction.

### TECHNICAL FIELD

The present invention relates to a thermal head and a thermal printer.

### BACKGROUND ART

In the related art, various thermal heads have been proposed as printing devices such as facsimiles or video printers. For example, there is known a thermal head including a substrate, a head base body including a plurality of heat generating sections disposed on the substrate, a connection member which connects the head base body to an outside via connection portions, and a first cover member covering the connection portions (for example, see Patent Literature 1).

### CITATION LIST

### Patent Literature

Patent Literature 1: Japanese Unexamined Patent Publication JP-A 2004-148577

### SUMMARY OF INVENTION

A thermal head according to the present disclosure includes a head base body, a connection member, and a first cover member. The head base body includes a substrate and a plurality of heat generating sections disposed on the substrate. The connection member connects the head base body to an outside via connection portions. The first cover member covers the connection portions. The first cover member includes a plurality of protruding portions provided on an upper surface of the first cover member at predetermined intervals in a main scanning direction.

A thermal head according to the present disclosure includes a head base body, a wiring substrate, a connection member, and a first cover member. The head base body includes a substrate and a plurality of heat generating sections disposed on the substrate. The wiring substrate is disposed so as to be adjacent to the head base body and is electrically connected thereto. The connection member connects the wiring substrate to an outside via connection portions. The first cover member covers the connection portions. The first cover member includes a plurality of protruding portions provided on an upper surface of the first cover member at predetermined intervals in a main scanning direction.

A thermal printer according to the present disclosure includes: the thermal head mentioned above; a conveyance mechanism which conveys a recording medium on the heat generating sections; and a platen roller which presses a recording medium against a top of the heat generating sections.

### BRIEF DESCRIPTION OF DRAWINGS

FIGS. 1A and 1B illustrate a thermal head according to a first embodiment, wherein FIG. 1A is a plan view illustrating a schematic configuration, and FIG. 1B is an explanation view illustrating a cross section of the schematic configuration;

FIG. 2 is a plan view illustrating the thermal head according to the first embodiment;

FIG. 3 is a sectional view taken along the line illustrated in FIG. 2;

FIG. 4 is a sectional view taken along the line IV-IV illustrated in FIG. 2;

FIG. 5A is a view illustrating a schematic configuration of the thermal printer according to the first embodiment, and FIG. 5B is a view illustrating a conveyance state of a recording medium;

FIGS. 6A and 6B illustrate a thermal head according to a second embodiment, wherein FIG. 6A is a plan view illustrating a schematic configuration, and FIG. 6B is an explanation view illustrating a cross section the schematic configuration;

FIG. 7 is a sectional view illustrating a part of the thermal head according to the second embodiment;

FIG. 8 is a sectional view corresponding to FIG. 4 and illustrating the thermal head according to the second embodiment;

FIG. 9 is a sectional view corresponding to FIG. 4 and illustrating a thermal head according to a third embodiment; and

FIG. 10 is a sectional view corresponding to FIG. 4 and illustrating a thermal head according to a fourth embodiment.

### DESCRIPTION OF EMBODIMENTS

Hereinafter, embodiments will be described with reference to the drawings. The drawings to be described below are schematic, and dimensions, scales, and the like in the drawings do not necessarily match actual dimensions, scales, and the like. Even in the plurality of drawings illustrating the same members, dimensions, scales, and the like do not match each other to exaggerate the shapes or the like in some cases.

### First Embodiment

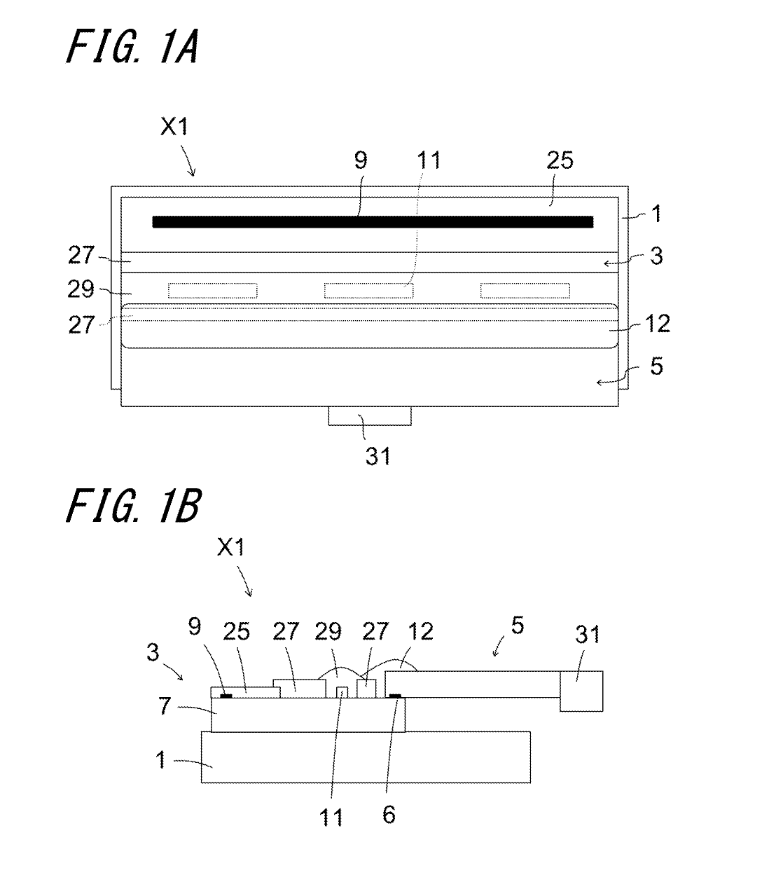

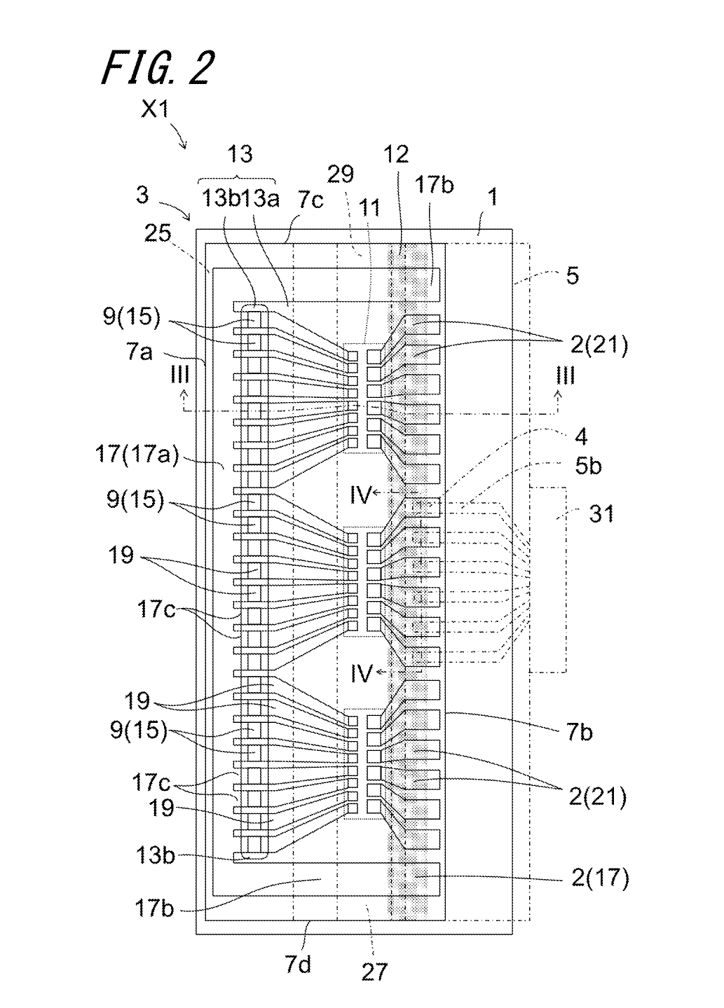

Hereinafter, a thermal head X1 will be described with reference to FIGS. 1A to 4. FIGS. 1A and 1B illustrate a schematic configuration of the thermal head X1. A heat generating section 9 and a connection portion 6 are indicated by a thick line, and a thermal storage layer 13 is not illustrated. In FIG. 2, a protective layer 25, a second cover member 29, a cover layer 27, a flexible printed circuit 5 (hereinafter referred to as an FPC 5), and a connector 31 are indicated by one-dot chain lines, although not illustrated. In FIG. 2, a first cover member 12 is indicated by a plurality of dots. In FIG. 2, some of wiring conductors 5b of the FPC 5 are selectively illustrated.

The thermal head X1 includes a heat dissipating plate 1, a head base body 3, the FPC 5 which is a connection member, and the first cover member 12. The head base body 3 is placed on the heat dissipating plate 1, and the FPC 5 is electrically connected. The head base body 3 and the FPC 5 are electrically connected to each other via a connection portion 6. The first cover member 12 is provided on the head base body 3 and the FPC 5 so as to cover the connection portion 6, and is formed to be long in a main scanning direction. The connector 31 is electrically connected to the FPC 5, and thus the thermal head X1 is electrically connected to the outside.

The heat dissipating plate 1 is formed of, for example, a metal material such as copper, iron, or aluminum. The heat dissipating plate 1 functions to dissipate part of the heat the heat evolved in the heat generating section 9 of the head base body 3 which part is not conducive to printing. The heat dissipating plate 1 is formed in a rectangular shape in a plan view. The head base body 3 is bonded on the upper surface of the heat dissipating plate 1 by a double-sided tape, an adhesive, or the like (not illustrated).

The head base body 3 is formed in a rectangular shape in a plan view. As illustrated in FIGS. 1A and 1B, the head base body 3 includes a substrate 7, the heat generating section 9, the protective layer 25, the cover layer 27, a driving IC (Integrated Circuit) 11, the first cover member 12, and the second cover member 29. Each member constituting the thermal head X1 is disposed on the substrate 7. The head base body 3 has a function of performing printing on a recording medium (not illustrated) in accordance with an electric signal supplied from the outside.

The protective layer 25 is formed to be long in the main scanning direction so as to cover the heat generating section 9. The cover layer 27 is disposed on the substrate 7 to be long in the main scanning direction. The driving IC 11 is disposed on the substrate 7 exposed from the cover layer 27. The plurality of driving ICs 11 are provided in the main scanning direction. The second cover member 29 covers the plurality of driving ICs 11 collectively. Therefore, the second cover member 29 is formed to be long in the main scanning direction.

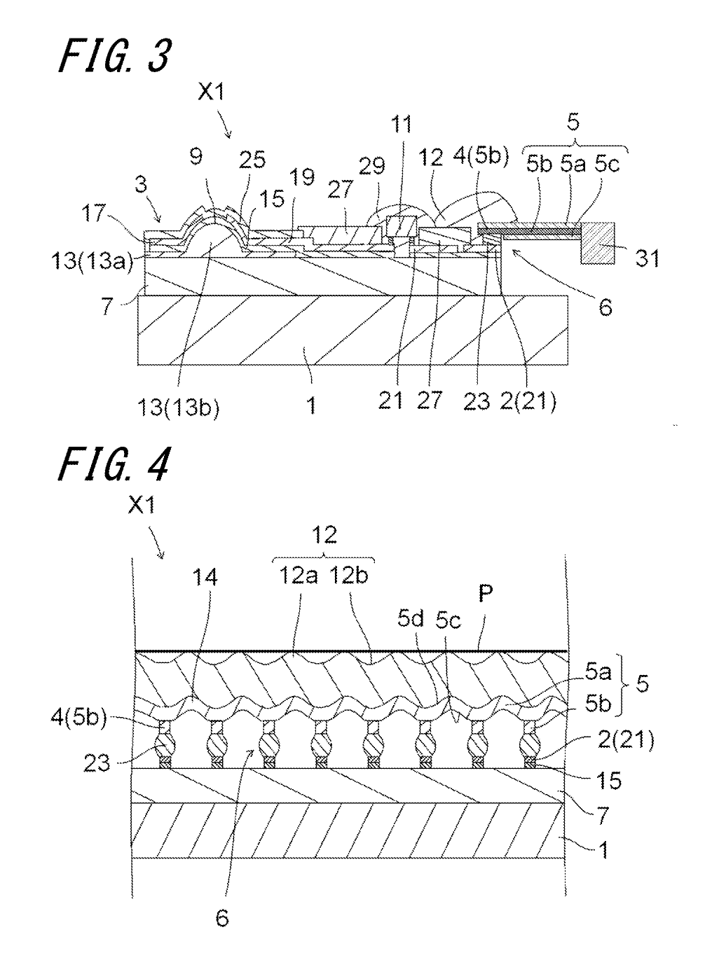

Hereinafter, the head base body 3 and each member included in the FPC 5 will be described in detail with reference to FIGS. 2 and 3. In the first embodiment, the FPC 5 will be described as the connection member.

The substrate 7 is disposed on the heat dissipating plate and is formed in a rectangular shape in a plan view. Therefore, the substrate 7 includes a first long side 7a, a second long side 7b, a first short side 7c, and a second short side 7d. The substrate 7 is formed of, for example, an electrically insulating material such as alumina ceramics or a semiconductor material such as a monocrystalline silicon.

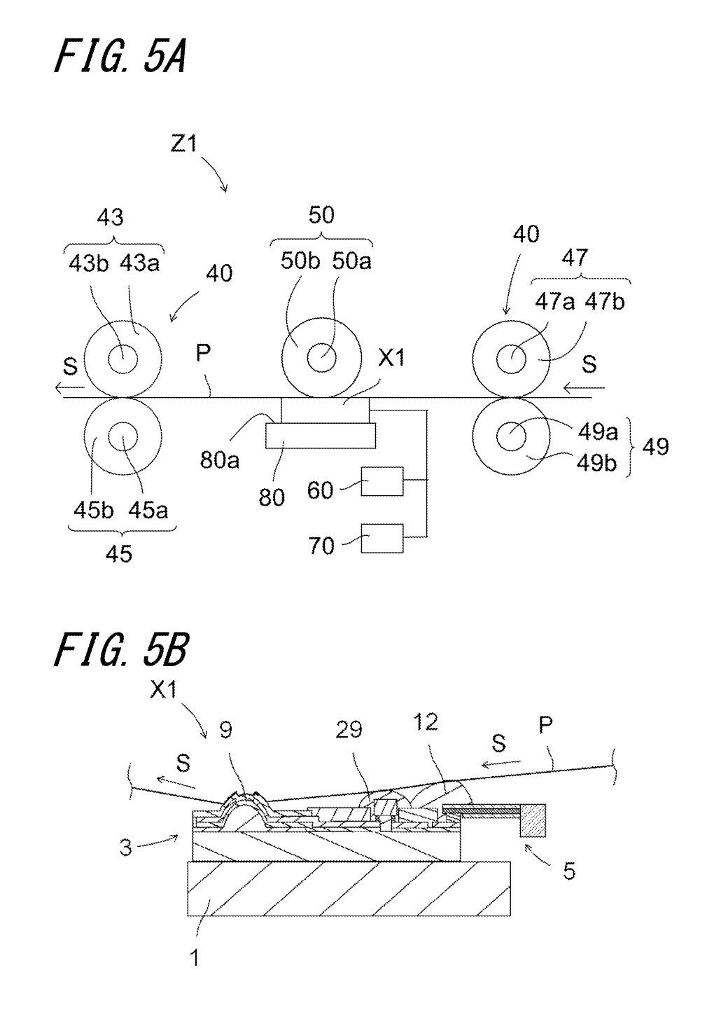

The thermal storage layer 13 is formed on the upper surface of the substrate 7. The thermal storage layer 13 includes an underlying portion 13a and a bulge portion 13b. The underlying portion 13a is formed across the left half of the upper surface of the substrate 7. The bulge portion 13b extends in a belt shape in the main scanning direction and has a cross section formed in a substantially semielliptical shape. The bulge portion 13b has a function of pressing a recording medium P (see FIG. 5B) to be printed satisfactorily against the protective layer 25 disposed on the heat generating section 9.

The thermal storage layer 13 is formed of glass with low thermal conductivity. The thermal storage layer 13 temporarily stores part of the heat generated by the heat generating section 9. Thus, it is possible to shorten a time necessary to increase the temperature of the heat generating section 9. Therefore, it is possible to improve a thermal responsive property of the thermal head X1.

The thermal storage layer 13 can be formed, for example, by applying a predetermined glass paste obtained by mixing an appropriate organic solvent with glass powder to the upper surface of the substrate 7 using heretofore known screen printing or otherwise, and firing the applied glass paste at high temperature.

An electrical resistance layer 15 is disposed on the upper surface of the thermal storage layer 13. Terminals 2, a common electrode 17, discrete electrodes 19, and connection electrodes 21 are disposed on the electrical resistance layer 15. The electrical resistance layer 15 is patterned with the same shape as the terminals 2, the common electrode 17, the discrete electrodes 19, and the connection electrodes 21. The electrical resistance layer 15 has exposed regions in which the electrical resistance layer 15 is exposed from the various electrodes between the common electrode 17 and the discrete electrodes 19. As illustrated in FIG. 2, the exposed regions of the electrical resistance layer 15 are arranged in line on the bulge portion 13b of the thermal storage layer 13. Each exposed region of the electrical resistance layer 15 forms the heat generating section 9.

The electrical resistance layer 15 may not be patterned with the same shape as the terminals 2, the common electrode 17, the discrete electrodes 19, and the connection electrodes 21. For example, the electrical resistance layer 15 may be disposed only between the common electrode 17 and the discrete electrodes 19 to form the heat generating section 9.

The heat generating section 9, while being illustrated in simplified form in FIGS. 1A and 1B for convenience in explanation, is arranged at a density of 100 dpi (dot per inch) to 2400 dpi, for example.

The electrical resistance layer 15 is formed of a material having a relatively high electrical resistance value such for example as a TaN-based material, a TaSiO-based material, a TaSiNO-based material, a TiSiO-based material, a TiSiCO-based material, or a NbSiO-based material. Hence, upon application of a voltage to the heat generating section 9, the heat generating section 9 generates heat under Joule heating effect.

The common electrode 17, the discrete electrodes 19, and the connection electrodes 21 are disposed on the upper surface of the electrical resistance layer 15. The common electrode 17, the discrete electrodes 19, and the connection electrodes 21 are formed of a material with conductivity. For example, these electrodes are formed of one of metal of aluminum, gold, silver, and copper or an alloy thereof.

The common electrode 17 includes main wiring portions 17a, sub wiring portions 17b, and lead portions 17c. The main wiring portion 17a extends along a first long side 7a of the substrate 7. Two sub wiring portions 17b extend along a first short side 7c and a second short side 7d of the substrate 7. The plurality of lead portions 17c individually extend from the main wiring portion 17a to each heat generating section 9. The common electrode 17 includes the terminals 2 connected to external terminals 4 on the side of a second long side 7b of the substrate 7.

The plurality of discrete electrodes 19 electrically connect the heat generating sections 9 to the driving ICs 11. For the discrete electrodes 19, the plurality of heat generating sections 9 are divided into a plurality of groups, and thus the heat generating sections 9 of each group are electrically connected to the driving IC 11 provided to correspond to each group.

A plurality of connection electrodes 21 electrically connect the driving ICs 11 to the connector 31. The plurality of connection electrodes 21 connected to each driving IC 11 are constituted by a plurality of wirings with different functions. The connection electrode 21 includes the terminal 2 connected to the connection portion 6 on the side of the second long side 7b of the substrate 7.

The terminal 2 is provided in the common electrode 17 and the connection electrode 21 to connect the head base body 3 to the FPC 5, and is disposed on the side of the second long side 7b of the substrate 7. The terminal 2 is formed by a part of the common electrode 17 and a part of the connection electrode 21.

The electrical resistance layer 15, the common electrode 17, the discrete electrodes 19, and the connection electrodes 21 can be formed in accordance with, for example, the following method. First, respective material layers are sequentially stacked on the thermal storage layer 13 by, for example, a heretofore known thin film forming technology such as a sputtering method. Subsequently, the material layers are formed by processing a stacked body in a predetermined pattern using a heretofore known photoetching or otherwise. The electrical resistance layer 15, the common electrode 17, the discrete electrodes 19, and the connection electrodes 21 can be simultaneously formed through the same processes.

The protective layer 25 covering the heat generating sections 9, a part of the common electrode 17, and parts of the discrete electrodes 19 is formed on the thermal storage layer 13 formed on the upper surface of the substrate 7.

The protective layer 25 protects the heat generating section 9 and the covered areas of the common electrode 17 and the discrete electrode 19 against corrosion caused by adhesion of atmospheric water content, etc., or against wear caused by contact with a recording medium under printing. The protective layer 25 may be formed of an inorganic material such as SiN, SiO₂, SiON, SiC, or diamond-like carbon. The protective layer 25 may be formed of a single layer or may be formed by stacking such layers. The protective layer 25 may be produced by thin-film forming technique such as sputtering, or thick-film forming technique such as screen printing.

On the substrate 7, there is provided a cover layer 27 which partly covers the common electrode 17, the discrete electrode 19, and the connection electrode 21. The cover layer 27 protects the covered areas of the common electrode 17, the discrete electrode 19, the IC-IC connection electrode 26, and the connection electrode 21 against oxidation caused by exposure to air. The cover layer 27 serves to protect the various electrodes against corrosion caused due to adherence of moisture contained in the air.

The driving ICs 11 are disposed to correspond to each group of the plurality of heat generating sections 9. The driving ICs 11 connect the discrete electrodes 19 to the connection electrodes 21. The plurality of driving ICs 11 are provided at predetermined intervals in the main scanning direction. The predetermined intervals are, for example, about 1 mm to 20 mm.

The driving IC 11 has a function of controlling a conductive state of each heat generating section 9. As the driving IC 11, for example, a switching member containing a plurality of switching elements is used. The driving ICs 11 are sealed by the second cover member 29.

The second cover member 29 is formed astride the plurality of driving ICs 11 to extend in the main scanning direction. The second cover member 29 covers the driving ICs 11 so that the driving ICs 11 are not exposed. The second cover member 29 also covers connection regions of the driving ICs 11 and the wirings.

The second cover member 29 can be formed of, for example, a thermosetting resin such as an epoxy resin or a silicone resin. The second cover member 29 can be formed using an ultraviolet-curable resin, a visible light-curable resin, or the like.

The FPC 5 includes a base member 5a, a plurality of wiring conductors 5b, and a cover member 5c. The base member 5a is formed in a rectangular shape in a plan view, and thus has the external shape as the FPC 5. The plurality of wiring conductors 5b are disposed on the base member 5a and are provided at predetermined intervals in the main scanning direction. An external terminal 4 electrically connected to the terminal 2 is disposed at an end of each of the plurality of wiring conductors 5b. Therefore, the plurality of external terminals 4 are provided apart from each other at the predetermined intervals in the main scanning direction. The cover member 5c is formed on the base member 5a to cover the wiring conductors 5b. The cover member 5c is partially notched so that the external terminals 4 are exposed. The wiring conductors 5b and the external terminals 4 may be formed of the same material to be integrated. In this case, portions of the wiring conductors 5b exposed from the cover member 5c serve as the external terminals 4.

The connector 31 is electrically connected to the wiring conductors 5b, sockets are inserted into the housing of the connector 31 from the outside, and the thermal head X1 is electrically connected to the outside.

As illustrated in FIG. 3, a conductive member 23 is disposed between the terminal 2 and the external terminal 4. The conductive member 23 electrically connects the terminal 2 to the external terminal 4. Examples of the conductive member 23 include, for example, solder or an anisotropic conducting adhesive. In the embodiment, the case where solder is used is described. A plated layer (not illustrated) formed of Ni, Au, or Pd may be disposed between the conductive member 23 and the terminal 2.

The connection portion 6 is a portion which electrically connects the head base body 3 to the FPC 5 (connection member). Therefore, in the first embodiment, the connection portion 6 means the conductive member 23.

The plurality of external terminals 4 are provided at predetermined intervals in the main scanning direction. Therefore, the plurality of connection portions 6 are also provided at the predetermined intervals in the main scanning direction. In the FPC 5, a region in which the connection portions 6 are arranged is referred to as a connection region (not illustrated) below. In other words, the connection region is a region between the external terminal 4 located on the farthest side of the first short side 7c of the substrate 7 and the external terminal 4 located on the farthest side of the second short side 7d of the substrate 7 in a plan view.

The first cover member 12 serves to protect the connection region. Therefore, the first cover member 12 is disposed on the head base body 3 and the FPC 5 to extend in the main scanning direction. That is, the first cover member 12 extends from the connection region of the FPC 5 to the head base body 3 adjacent to the connection region in a sub-scanning direction.

The first cover member 12 can be formed of a thermosetting resin such as an epoxy resin or a silicone resin as in the second cover member 29. The first cover member 12 can be formed of an ultraviolet-curable resin, a visible light-curable resin, or the like.

The first cover member 12 and the FPC 5 will be described in detail with reference to FIG. 4. In FIG. 4, the recording medium P being conveyed is schematically indicated by a black line.

The first cover member 12 includes a plurality of protruding portions 12a provided at predetermined intervals in the main scanning direction. The first cover member 12 includes a plurality of recessed portions 12b provided at predetermined intervals in the main scanning direction. The plurality of protruding portions 12a and the plurality of recessed portions 12b are provided on the upper surface of the first cover member 12. The plurality of protruding portions 12a and the plurality of recessed portions 12b are alternately formed. The plurality of protruding portions 12a and the plurality of recessed portions 12b are provided above the connection region.

An interval between the adjacent protruding portions 12a is, for example, 50 to 200 μm. An interval between the adjacent recessed portions 12b is, for example, 50 to 200 μm. The interval between the adjacent protruding portions 12a indicates a distance between portions located highest among the protruding portions 12a in the main scanning direction. The same applies to the interval between the adjacent recessed portions 12b.

A difference between the heights of the protruding portions 12a and the recessed portions 12b can be set to, for example, 20 to 40 μm. The difference between the heights of the protruding portions 12a and the recessed portions 12b can be measured by observing a surface state of the first cover member 12 with, for example, a contactless laser microscope.

The first cover member 12 is configured to be contactable with the recording medium P. In other words, the first cover member 12 may come into contact with the recording medium P depending on a conveyance situation of the recording medium P in some cases.

The base member 5a of the FPC 5 includes a first surface 5c located on the substrate side and a second surface 5d located opposite to the first surface 5c. On the first surface 5c, the wiring conductors 5b is formed, and the external terminals 4 are provided. The base member 5a includes a depression portion 14 in a region in which the external terminal 4 is not provided.

The depression portion 14 is depressed from a first surface 5c toward a second surface 5d in a region in which the external terminal 4 is provided. The depression portion 14 is formed in the region of the first surface 5c in which the external terminal 4 is not provided. In other words, the depression portion 14 is formed between the external terminals 4. Therefore, the plurality of depression portions 14 are provided at predetermined intervals in the main scanning direction.

The second surface 5d corresponding to the depression portion 14 protrudes upwardly. The plurality of depression portions 14 are provided at the predetermined intervals in the main scanning direction, and thus the second surface 5d includes protruding portions provided at the predetermined intervals in the main scanning direction.

A depth of the depression portion 14 from the first surface 5c of the region in which the external terminal 4 is provided (a length in a thickness direction of the substrate 7) can be set to be, for example, 20 to 40 μm. The depth of the depression portion 14 from the first surface 5c of the region in which the external terminal 4 is provided can be obtained, for example, by cutting the thermal head X1 in the vertical direction as in FIG. 4 and observing the cross-sectional surface of the FPC 5.

Here, when a recording medium comes into contact with the first cover member including no protruding portion, the upper surface of the first cover member is flat, and thus the recording medium comes into surface contact with the first cover member. Thus, friction between the recording medium and the first cover member may increase, the recording medium is caught, and thus there is a concern that the recording medium is wrinkled.

On the other hand, the first cover member 12 includes the plurality of protruding portions 12a provided on the upper surface at the predetermined intervals in the main scanning direction. Therefore, even when the first cover member 12 comes into contact with the recording medium P, the recording medium P comes into contact with the protruding portions 12a, but is less likely to come into contact with the recessed portions 12b between the protruding portions 12a. Thus, the recording medium P comes into point contact with the first cover member 12. Therefore, the friction between the recording medium P and the first cover member 12 does not increase and the recording medium P is less likely to be caught. As a result, the recording medium is less likely to be wrinkled.

In particular, the case of the thermal head X1 in which a glossy sheet is used as the recording medium P is useful because of the following reasons. A glossy sheet has strong resilience as the recording medium P and the recording medium P is further less likely to come into contact the recessed portions 12b. As a result, the recording medium P comes into point contact with the first cover member 12, and thus it is possible to reduce a possibility that the recording medium P is wrinkled and paper jamming occurs.

The first cover member 12 can be formed of an epoxy-based resin. Thus, static electricity charged to the recording medium P is discharged to, for example, the heat dissipating plate 1 through the first cover member 12. Thus, the static electricity is less likely to be discharged to the heat generating section 9. As a result, the thermal head X1 is less likely to be damaged.

The protruding portions 12a are provided on a part of the upper surface of the first cover member 12 which part is located above the connection region. Thus, it is possible to reduce noise caused due to an electric signal flowing in the connection portion 6.

That is, since the protruding portions 12a are provided on the upper surface of the first cover member 12, the surface area of the upper surface can be set to be greater than the surface area of the flat upper surface. Thus, it is likely to radiate the noise from the upper surface of the first cover member 12, and thus it is possible to reduce an influence of the noise of the connection portion 6.

The second cover member 29 is provided between the heat generating section 9 and the first cover member 12 in a plan view. In other words, the first cover member 12, the second cover member 29, and the heat generating section 9 are disposed in this order when viewed in a conveying direction of the recording medium P.

Therefore, the recording medium P comes into contact with the protruding portions 12a of the first cover member 12 and subsequently comes into contact with the second cover member 29 after electricity is removed. As a result, static electricity is discharged to the second cover member 29, and thus the driving IC 11 is less likely to be damaged.

The protruding portions 12a are disposed at positions corresponding to the depression portions 14 of the second surface 5d. Therefore, even when the recording medium P is excessively pressed against a platen roller 50 (see FIG. 5A), the depression portions 14 can be deformed and the protruding portions 12a can be displaced downwards. Therefore, the depression portions 14 can alleviate stress concentrated on the protruding portions 12a. As a result, damage such as crack is less likely to occur in the first cover member 12.

Here, the recording medium P can be conveyed by various rollers, as illustrated in FIG. 5A. Therefore, there is a concern that the recording medium P is at a high temperature due to friction heat generated between the recording medium P and the various rollers.

On the other hand, in the thermal head X1, space is provided between the depression portion 14 and the substrate 7. Thus, a heat insulating layer is formed between the protruding portions 12a and the substrate 7 and between the depression portions 14 and the substrate 7, and the heat of the recording medium P is less likely to be transferred to the substrate 7.

The first cover member 12 includes the recessed portions 12b between the protruding portions 12a, and the recessed portions 12b are disposed on the terminal 2. In other words, the protruding portion 12a coming into contact with the recording medium P is not disposed on the terminal 2. Therefore, even when static electricity charged to the recording medium P is discharged to the first cover member 12, the static electricity is discharged to the protruding portion 12a located closely. Therefore, it is possible to reduce a possibility of the static electricity discharged to the terminal 2. As a result, the terminal 2 is less likely to be destroyed by the static electricity.

The thermal head X1 can be manufactured according to the following method, for example.

First, the external terminals 4 of the FPC 5 are electrically connected to the terminals 2 of the head base body 3 via the conductive members 23. Subsequently, the conductive members 23 are reflowed to electrically connect the terminals 2 of the head base body 3 to the external terminals 4 of the FPC 5.

Subsequently, the first cover member 12 is applied with a constant thickness using a dispenser or the like so that the connection portions 6 are sealed, and is cured. Continuously, the first cover member 12 is applied again by the dispenser in portions in which the protruding portions 12a are formed, and is dried. Thus, the protruding portions 12a can be formed on the upper surface of the first cover member 12.

After the first cover member 12 is applied with a constant thickness using the dispenser or the like so that the connection portions 6 are sealed, a pressing plate with an uneven surface may be pressed against an applied surface to form the protruding portions 12a.

An example in which the protruding portions 12a and the recessed portions 12b are provided in the connection region has been described, but the invention is not limited to this. The protruding portions 12a and the recessed portions 12b may be formed on an upper surface of the first cover member 12 other than the connection region.

A configuration in which the base member 5a includes the depression portions 14 has been described, but the depression portions 14 may not be provided.

Next, a thermal printer Z1 will be described with reference to FIGS. 5A and 5B.

As illustrated in FIG. 5A, the thermal printer Z1 according to the embodiment includes the above-described thermal head X1, a conveyance mechanism 40, a platen roller 50, a power supply device 60, and a control unit 70. The thermal head X1 is mounted on a mounting surface 80a of a mounting member 80 provided in a housing (not illustrated) of the thermal printer Z1. The thermal head X1 is mounted in the mounting member 80 so that the arrangement direction of the heat generating sections 9 follows the main scanning direction which is a direction perpendicular to a conveying direction S of the recording medium P to be described below.

The conveyance mechanism 40 comprises a driving section (not shown) and conveying rollers 43, 45, 47 and 49. The conveyance mechanism 40 serves to convey the recording medium P such as thermal paper or ink-transferable image-receiving paper, in a direction indicated by the arrow S shown in FIGS. 5A and 5B so as to move the recording medium P onto the protective layer 25 located on the plurality of heat generating sections 9 of the thermal head X1. The driving section functions to drive the conveying rollers 43, 45, 47 and 49, and, for example, a motor may be used for the driving section. For example, the conveying roller 43, 45, 47, 49 is composed of a cylindrical shaft body 43a, 45a, 47a, 49a formed of metal such as stainless steel covered with an elastic member 43b, 45b, 47b, 49b formed of butadiene rubber, for example. Although not shown in the drawing, when using ink-transferable image-receiving paper or the like as the recording medium P, the recording medium P is conveyed together with an ink film which lies between the recording medium P and the heat generating section 9 of the thermal head X1.

The platen roller 50 functions to press the recording medium P against the top of the protective layer 25 located on the heat generating section 9 of the thermal head X1. The platen roller 50 is disposed so as to extend along a direction perpendicular to the conveying direction S of the recording medium P, and is fixedly supported at ends thereof so as to be rotatable while pressing the recording medium P against the top of the heat generating section 9. For example, the platen roller 50 may be composed of a cylindrical shaft body 50a formed of metal such as stainless steel covered with an elastic member 50b formed of butadiene rubber, for example.

The power supply device 60 functions to supply electric current for enabling the heat generating section 9 of the thermal head X1 to generate heat as described above, as well as electric current for operating the driving IC 11. The control unit 70 functions to feed a control signal for controlling the operation of the driving IC 11 to the driving IC 11 in order to cause the heat generating sections 9 of the thermal head X1 to selectively generate heat as described above.

As illustrated in FIG. 5B, in the thermal printer Z1, the second cover member 29 is disposed upstream in the conveying direction S from the first cover member 12. For the recording medium P, predetermined printing is performed on the recording medium P when the power supply device 60 and the control device 70 causes the heat generating sections 9 to selectively generate heat while causing the platen roller 50 to press the recording medium P against a top of the heat generating sections 9 of the thermal head X1 and causing the conveyance mechanism 40 to convey the recording medium P onto the heat generating sections 9 so that the recording medium P sequentially comes into contact with the first cover member 12 and the second cover member 29. When the recording medium P is an image-receiving sheet, the printing is performed on the recording medium P by thermally transferring ink of an ink film (not illustrated) conveyed along with the recording medium P to the recording medium P.

### Second Embodiment

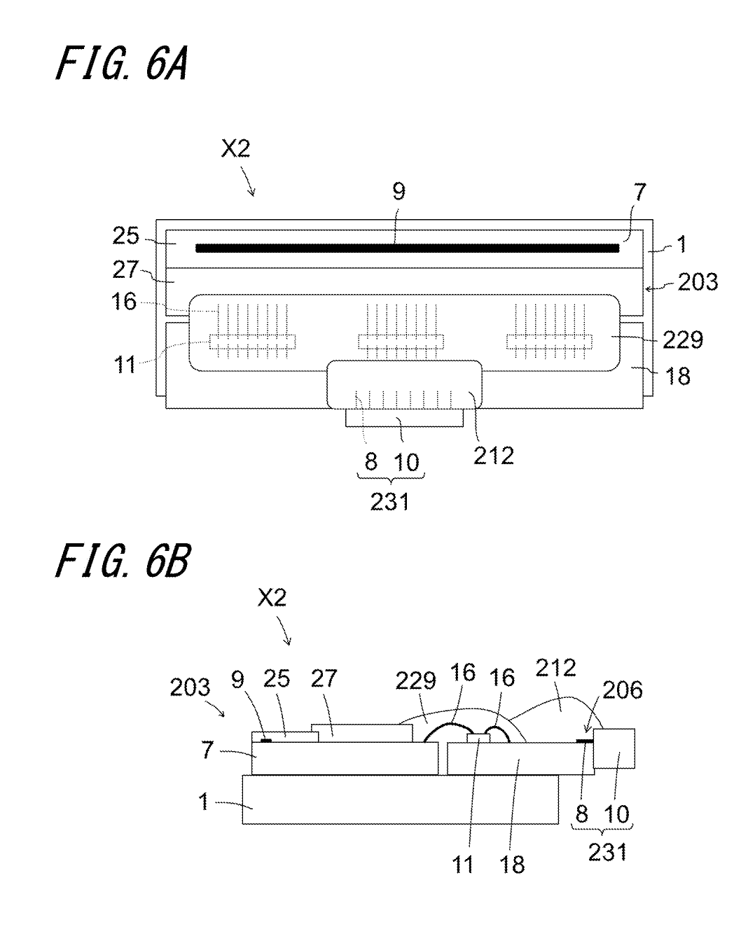

A thermal head X2 will be described with reference to FIGS. 6A to 8. The same reference numerals are given to the same members as those of the first embodiment. In FIGS. 6A and 6B, the heat generating section 9, connector pins 8, and wires 16 are indicated by thick lines.

The thermal head X2 includes a heat dissipating plate 1, a head base body 203, a wiring substrate 18, a connector 231 which is a connection member, and a first cover member 212. The head base body 203 and the wiring substrate 18 are placed on the heat dissipating plate 1. The connector 231 is electrically connected to the wiring substrate 18. In a second embodiment, the connector 231 will be described as the connection member.

The plurality of driving ICs 11 are disposed on the wiring substrate 18 and the wires 16 disposed on the upper surface of the driving ICs 11 electrically connect the head base body 203 to the wiring substrate 18. A second cover member 229 is configured to cover the plurality of driving ICs 11. The second cover member 229 is formed to be long in the main scanning direction.

The connector 231 includes the connector pins 8 and a housing 10. The connector pins 8 are electrically connected to the wiring substrate 18. The housing 10 accommodates the connector pins 8. The sockets are inserted into the housing 10 from the outside so that the head base body 203 is electrically connected to the outside.

The first cover member 212 is provided on the wiring substrate 18 and the housing 10 so as to cover a connection portions 206.

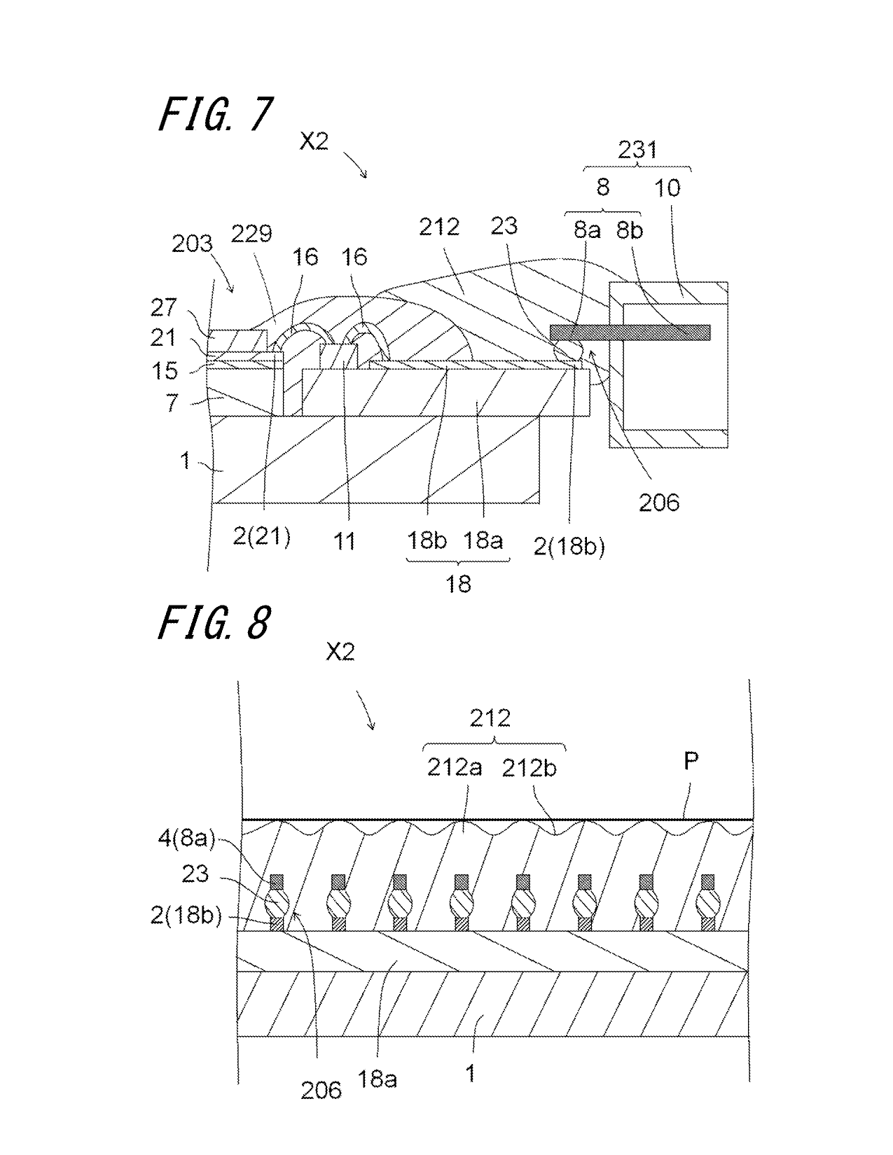

The wiring substrate 18, the connector 231, and the first cover member 212 will be described in detail with reference to FIGS. 7 and 8.

The wiring substrate 18 is placed on the upper surface of the heat dissipating plate 1 to be adjacent to the head base body 203. The wiring substrate 18 includes a base member 18a and a wiring conductor 18b. The driving ICs 11 and the wires 16 are disposed on the wiring substrate 18.

The base member 18a is formed in a rectangular shape in a plan view and has substantially the same shape as the wiring substrate 18. The wiring conductor 18b is provided in the base member 18a and is patterned in a planar direction, although not illustrated. The wiring conductor 18b includes the terminal 2 electrically connected to a connection portion 206 on the side of the connector 231. The terminals 2 are provided at predetermined intervals in the main scanning direction.

The driving IC 11 is placed in a region in which the wiring conductor 18b is not provided on the base member 18a. One pair of wires 16 is extracted from the upper surface of the driving IC 11, and includes a first wire 16 and a second wire 16. The first wire 16 is electrically connected to the connection electrode 21 of the head base body 3. The second wire 16 is electrically connected to the wiring conductor 18b of the wiring substrate 18.

In the connector 231, the housing 10 is disposed at intervals from the side surface of the wiring substrate 18. Each of the plurality of connector pins 8 includes a first end 8a and a second end 8b. The first end 8a is exposed to the outside of the housing 10 and is electrically connected to the terminal 2. That is, the first end 8a functions as the external terminal 4 of the connector (connection member) 231. The second end 8b is accommodated inside the housing 10. The connector pins 8 have electrical conductivity and can be formed of metal or an alloy. The housing 10 can be formed of an insulating member.

The first end 8a is electrically connected to the terminal 2 of the wiring substrate 18 via the conductive member 23. Therefore, in the second embodiment, the connection portion 206 is constituted by the conductive member 23.

The first cover member 212 is provided to protect the connection region and is provided to cover the terminals 2, the conductive members 23, and the first ends 8a. In the present embodiment, the first cover member 212 is provided over the entire region of the terminals 2, the conductive members 23, and the first ends 8a. Therefore, the first cover member 212 seals the terminals 2, the conductive members 23, and the first ends 8a. A part of the first cover member 212 is disposed on the housing 10 of the second cover member 29.

As illustrated in FIG. 8, the first cover member 212 includes a plurality of protruding portions 212a provided at predetermined intervals in the main scanning direction. The first cover member 212 includes a plurality of recessed portions 212b provided at predetermined intervals in the main scanning direction. The plurality of protruding portions 212a and the plurality of recessed portions 212b are provided on the upper surface of the first cover member 212. The plurality of protruding portions 212a and the plurality of recessed portions 212b are alternately provided in the main scanning direction. The plurality of protruding portions 212a and the plurality of recessed portions 212b are formed above the connection region.

An interval between the mutually adjacent protruding portions 212a is, for example, 1 to 5 mm. An interval between the adjacent recessed portions 212b is, for example, 1 to 5 mm.

A difference between the heights of the protruding portions 212a and the recessed portions 212b can be set to, for example, 50 to 200 μm. The difference between the heights of the protruding portions 212a and the recessed portions 212b can be measured by observing a surface state of the first cover member 212 with, for example, a contactless laser microscope.

The first cover member 212 is configured to be contactable with the recording medium P. That is, the recording medium P comes into contact with the first cover member 212, and subsequently comes into contact with the protective film 25 (see FIG. 3) on the heat generating sections 9 so that printing is performed.

The first cover member 212 includes the protruding portions 212a provided at the predetermined intervals in the main scanning direction on the upper surface. Thus, the recording medium P comes into contact with the protruding portions 212a and is less likely to come into contact with the recessed portions 212b located between the protruding portions 212a. Therefore, the recording medium P comes into point contact with the first cover member 212. Therefore, the friction between the recording medium P and the first cover member 212 does not increase and the recording medium P is less likely to be caught. As a result, the recording medium is less likely to be wrinkled.

The plurality of protruding portions 212a are provided at positions corresponding to the plurality of connector pins 8, respectively. Thus, the protruding portions 212a of the first cover member 212 can be supported by the connector pins 8, and the first cover member 212 can stably convey the recording medium P.

The first cover member 212 is disposed to surround the connection portions 206. Thus, mechanical connection of the connection portions 206 can be stabilized. As a result, it is possible to improve electric connection reliability of the connection portions 206.

### Third Embodiment

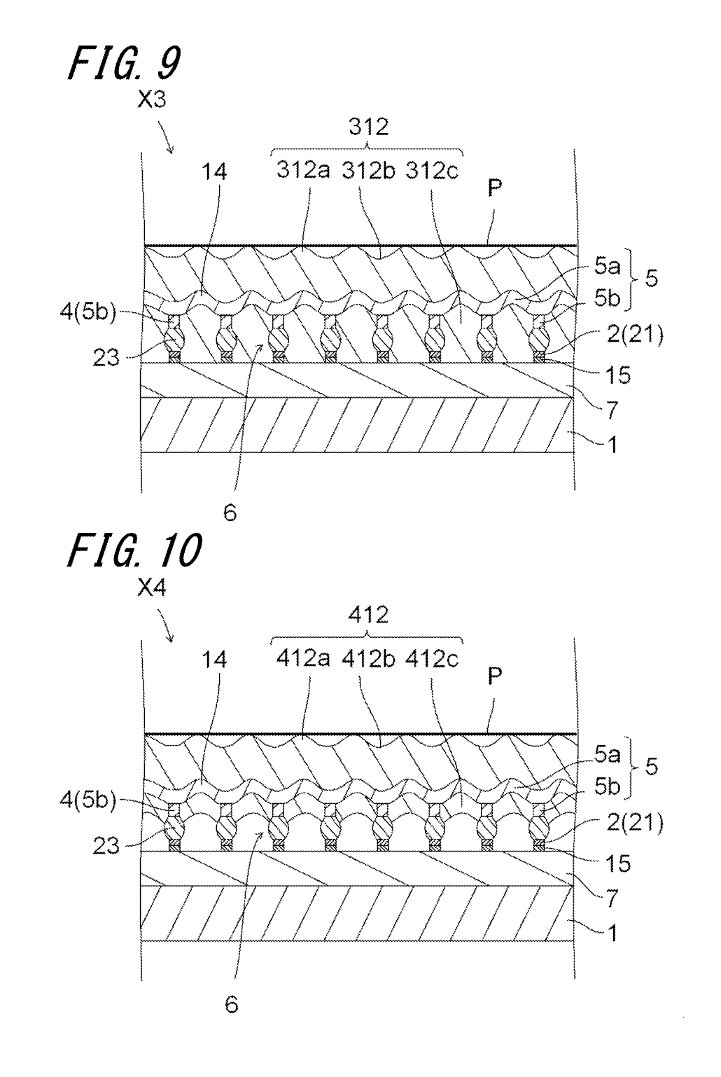

A thermal head X3 will be described with reference to FIG. 9. The thermal head X3 is different from the thermal head X1 in the configuration of a first cover member 312. The other configuration is the same as the thermal head X1 and the description thereof will be omitted.

The first cover member 312 includes a plurality of protruding portions 312a, a plurality of recessed portions 312b, and an infiltration portion 312c. The plurality of protruding portions 312a and the plurality of recessed portions 312b are provided on the upper surface of the first cover member 312. The infiltration portion 312c is disposed in a portion of the first cover member 312 located between the FPC 5 and the substrate 7. The infiltration portion 312c is filled between the FPC 5 and the substrate 7.

The infiltration portion 312c penetrates between the FPC 5 and the substrate 7, and thus an end of the FPC 5 located on the substrate 7 is sandwiched by the first cover member 312. In other words, the first cover member 312 is disposed over the entire region around the end of the FPC 5 located on the substrate 7. As a result, the end of the FPC 5 located on the substrate 7 is less likely to be separated. Therefore, the FPC 5 is less likely to be separated from the head base body 3.

Further, since the infiltration portion 312c is filled between the FPC 5 and the substrate 7, the first cover member 312 is disposed around the conductive members 23. Therefore, the infiltration portion 312c can protect the conductive members 23. As a result, the electric connection between the head base body 3 and the FPC 5 can be stabilized.

### Fourth Embodiment

A thermal head X4 will be described with reference to FIG. 10. The thermal head X4 is different from the thermal head X3 in the configuration of a first cover member 412. The other configuration is the same as the thermal head X3 and the description thereof will be omitted.

The first cover member 412 includes a protruding portion 412a, a recessed portion 412b, and an infiltration portion 412c. The infiltration portion 412c is provided on the side of the FPC 5 without being filled between the FPC 5 and the substrate 7. In other words, a space is provided between the infiltration portion 412c and the substrate 7. Therefore, a part of the conductive member 23 is provided to be exposed from the infiltration portion 412c. Then, the conductive member 23 is formed by solder.

Here, when the large quantity of infiltration portion 412c penetrates between the FPC 5 and the substrate 7, the conductive member 23 is pressed by the infiltration portion 412c, and thus there is a concern of contact with the nearby located conductive member 23. That is, there is a concern of short-circuiting.

On the other hand, in the thermal head X4, an inflow amount of the infiltration portion 412c can be reduced and a pressing force applied from the infiltration portion 412c can be reduced. As a result, the conductive member 23 is less likely to come into contact with the adjacent conductive member 23, and thus short-circuiting is less likely to occur in the thermal head X4.

Further, the infiltration portion 412c includes a portion located between the connection portions 6. Then, in the infiltration portion 412c, a surface of the portion located between the connection portions 6 on the side of the substrate 7 protrudes upwardly. More specifically, the surface of the infiltration portion 412c located between the conductive members 23 on the side of the substrate 7 has an upward protruding shape in a sectional view. Therefore, the infiltration portion 412c is easily deformed by a pressing force from above. Therefore, the infiltration portion 412c can disperse the pressing force from above.

In particular, when the infiltration portion 412c is located below the protruding portion 412a, the infiltration portion 412c can further disperse the pressing force from above. That is, the protruding portions 412a are configured to come into contact with the recording medium P, and thus a pressing force is applied to the protruding portions 412a downwards. On the other hand, the infiltration portion 412c serves to disperse the pressing force, and the first cover member 412 is less likely to be damaged by the pressing force.

While one embodiment according to the disclosure has been described heretofore, it should be understood that the invention is not limited to the above-described embodiment, and that various modifications and variations are possible without departing from the scope of the invention. For example, although the thermal printer Z1 employing the thermal head X1 according to the first embodiment has been shown herein, it is not intended to be limiting of the invention, and thus, any of the thermal heads X2 to X4 may be adopted for use in the thermal printer Z1. Moreover, the thermal heads X1 to X4 according to a plurality of embodiments may be used in combination.

In the thermal head X1, the bulge portion 13b is formed in the thermal storage layer 13 and the electrical resistance layer 15 is formed on the bulge portion 13b, but the invention is not limited to this. For example, the bulge portion 13b may not be formed in the thermal storage layer 13 and the heat generating section 9 of the electrical resistance layer 15 may be disposed on the underlying portion 13a of the thermal storage layer 13. The thermal storage layer 13 may be provided across the upper surface of the substrate 7.

In the thermal head X1, the common electrode 17 and the discrete electrode 19 are formed on the electrical resistance layer 15, but the invention is not limited to this as long as both the common electrode 17 and the discrete electrode 19 are connected to the heat generating section 9 (electric resistor). For example, the heat generating section 9 may be constituted by forming the common electrode 17 and the discrete electrode 19 on the thermal storage layer 13 and forming the electrical resistance layer 15 only in a region between the common electrode 17 and the discrete electrode 19.

Furthermore, although the thin-film head having the thin heat generating section 9 obtained by forming the electrical resistance layer 15 in thin-film form has been described as exemplification, the invention is not limited to this. For example, the invention may be embodied as a thick-film head having a thick heat generating section 9 by patterning various electrodes and subsequently forming the electrical resistance layer 15 in thick-film form. Further, the present technology may be embodied as an edge-type head in which the heat generating section 9 is disposed on an end face of the substrate.

### REFERENCE SIGNS LIST

X1-X4: Thermal head
Z1: Thermal printer
1: Heat dissipating plate
2: Terminal
3: Head base body
4: External terminal
5: Flexible printed circuit (connection member)
5a: Base member
5b: Wiring conductor
5c: Cover member
6, 206: Connection portion
7: Substrate
8: Connector pin
8a: First end
8b: Second end
9: Heat generating section
10: Housing
11: Driving IC
12, 212, 312, 412: First cover member
12a, 212a, 312a, 412a: Protruding portion
12b, 212b, 312b, 412b: Recessed portion
312c, 412c: Infiltration portion
14: Depression portion
16: Wire
18: Wiring substrate
18a: Base member
18b: Wiring conductor
23: Conductive member
29, 229: Second cover member
31, 231: Connector (connection member)

1. A thermal head, comprising:
a head base body including a substrate and a plurality of heat generating sections disposed on the substrate;
connection portions;
a connection member which connects the head base body to an outside via the connection portions; and
a first cover member which covers the connection portions,
the first cover member including a plurality of protruding portions provided on an upper surface of the first cover member at predetermined intervals in a main scanning direction.

2. A thermal head, comprising:
a head base body including a substrate and a plurality of heat generating sections disposed on the substrate;
a wiring substrate which is disposed so as to be adjacent to the head base body and is electrically connected thereto;
connection portions;
a connection member which connects the wiring substrate to an outside via the connection portions; and
a first cover member which covers the connection portions,
the first cover member including a plurality of protruding portions provided on an upper surface of the first cover member at predetermined intervals in a main scanning direction.

3. The thermal head according to claim 1 or 2, wherein the connection member includes a connection region electrically connected to the head base body or the wiring substrate, and
the plurality of protruding portions are provided on a part of the upper surface of the first cover member which part is located above the connection region.

4. The thermal head according to any one of claims 1 to 3, further comprising:
a driving IC which controls driving of the heat generating sections; and
a second cover member which covers the driving IC,
wherein the second cover member is provided between the heat generating sections and the first cover member in a plan view of the thermal head.

5. The thermal head according to any one of claims 1 to 4, wherein the head base body or the wiring substrate includes a plurality of terminals electrically connected to the connection member,
the connection member includes
a base member including a first surface located on a substrate side and a second surface located on an opposite side to the first surface,
a wiring conductor which is disposed on the first surface, and
a plurality of external terminals electrically connected to the plurality of terminals, respectively,
the base member includes depression portions in a region of the first surface in which the external terminals are not formed, and
the protruding portions of the first cover member are located at positions corresponding to the depression portions of the second surface.

6. The thermal head according to claim 5, wherein space is provided between the depression portions and the substrate.

7. The thermal head according to claim 5 or 6, wherein the first cover member includes recessed portions between the protruding portions, and
the recessed portions are disposed on the terminals, respectively.

8. The thermal head according to any one of claims 1 to 7, wherein the first cover member penetrates between the connection member and the head base body or the wiring substrate.

9. The thermal head according to claim 8, wherein the connection portions are formed of solder, and
the solder is exposed from the first cover member.

10. The thermal head according to claim 8 or 9, wherein in a sectional view of the thermal head, the first cover member penetrating between the connection member and the head base body or the wiring substrate includes a portion located between the connection portions, and
in the sectional view, a surface of the portion located between the connection portions on a substrate side protrudes upwardly.

11. The thermal head according to any one of claims 1 to 4, wherein the connection member includes a plurality of connector pins and a housing accommodating the plurality of connector pins, and
the plurality of protruding portions of the first cover member are disposed at positions corresponding to the plurality of connector pins, respectively.

12. A thermal printer, comprising:
the thermal head according to any one of claims 1 to 11;
a conveyance mechanism which conveys a recording medium on the heat generating sections; and
a platen roller which presses the recording medium against a top of the heat generating sections.
